(19) United States
(12) Patent Application Publication
(10) Pub. No.: US 2009/0056960 A1
(43) Pub. Date: Mar. 5, 2009

(54) Warehouse Zoned Sprinkler System

(76) Inventor: Jack Canady, Simpsonville, KY (US)

Correspondence Address: JAMES M. FRANCIS, 300 W VINE ST, STOLL KEENON OGDEN PLLC, LEXINGTON, KY, 40507, US

(21) Appl. No.: 12/034,630

(22) Filed: Feb. 20, 2008

Related U.S. Application Data
(60) Provisional application No. 60/890,834, filed on Feb. 20, 2007.

(51) Int. Cl. A62C 2/00; A62C 35/00

(52) U.S. Cl. 169/46; 169/13

(57) ABSTRACT

A fire prevention system optimized for warehouses, hangars, and similar structures that require zoned protection utilizing multiple risers to feed zoned arrays of sprinklers. The system is preferably supplied with water by a pump housed within the structure. The pump supplies water to a supply line that runs the interior perimeter of the building along the ceiling. Extremely large warehouses may require additional supply lines that run across the center of the building along the ceiling. Feeder lines run from the supply lines down to individual risers which control the water supply to individual sprinkler circuits arranged in zones that cover distinct areas.

### CROSS REFERENCE TO RELATED APPLICATIONS

This application claims priority from U.S. Provisional Application No. 60/890,834 filed on Feb. 20, 2007. This application relates to warehouse zoned sprinkler system. The entire disclosure contained in U.S. Provisional Application No. 60/890,834 including the attachments thereto, are incorporated herein by reference.

### BACKGROUND OF THE INVENTION

1. Field of the Invention

The present invention relates generally to fire suppression systems, more particularly the present relates to fire suppression systems for large structures employing numerous independently operated sprinkler systems intended to protect specific zones within the large structure. Even more specifically, the present relates to zoned closed loop sprinkler systems utilized for fire suppression that independently responds to fires within a specific zone wherein the retardant distribution system is located entirely within the structure to be protected.

2. Problems in the Art

Sprinklers have been in use in the United States since 1874, and were used in factory applications where fires at the turn of the century were often catastrophic in terms of both human and property losses. In the US, sprinklers are today required in all new high rise and underground buildings generally 75 feet (23 m) above or below fire department access, where the ability of firefighters to provide adequate hose streams to fires is limited. Sprinklers may also be required in hazardous storage spaces by building codes, or may be required by insurance companies where liability due to potential property losses or business interruptions can be reduced by adequate automatic fire protection. Building codes in the United States for places of assembly, generally over 100 persons, and places with overnight sleeping accommodation such as hotels, nursing homes, dormitories, and hospitals usually require sprinklers. A newer, special class of fire sprinklers, ESFR sprinklers, has been developed to fight, and subsequently suppress high challenge type fires. Current practice for the installation of zoned sprinkler systems for warehouses and aircraft hangars is to utilize a pump housed outside the structure and to run buried lines, typically polyvinyl chloride (PVC) pipes are buried in trenches surrounding the structures and feeder lines are run into the structure to supply the various zones at risers which control the flow of the flame retardant, typically water, so that adequate pressure is maintained in the remaining zones.

Burying the feeder lines can be expensive due to labor costs and purchasing or leasing the necessary equipment. Burying the lines also creates maintenance problems because leaks can go undetected and ground movement can break lines or damage seals and connections. Additionally, required maintenance would be conducted outside the building and subject to delays caused by variations in weather.

There are several types of sprinkler systems that are typically used with warehouse fire protection systems. Common “wet” systems are simple and passive. They have water already pressurized in the pipes held back by the sprinkler head. These systems require no manual controls to activate, so long as adequate water supplies are provided.

“Deluge” systems are systems that have open sprinklers, i.e. the fusible link is removed, so that every sprinkler served by the system will discharge water. This ensures a large and simultaneous application of water over the entire hazard. These systems are used for special hazards where rapid fire spread is a concern.

“Pre-Action” Systems are similar to “Deluge” except the sprinklers are closed and the system is filled with compressed air known as “maintenance air”. These systems are desirable where water discharged through accidental damage to the system piping and/or sprinklers presents an unacceptable loss risk to valuable Electronic Components or other water reactive materials and/or equipment. As the name implies, these systems require that a “preceding” and supervised event (typically the activation of a Heat or Smoke Detector) take place prior to the “action” of water introduction into the system's piping. There are basically three (3) types of Pre-Action systems including Interlock, Non-Interlock and Double-Interlock, all which offer differing levels of accidental water discharge protection.

### SUMMARY OF THE INVENTION

The present invention is a fire prevention system optimized for warehouses, hangars, and similar structures that require zoned protection utilizing multiple risers to feed zoned arrays of sprinklers. The system is preferably supplied with water by a pump housed within the structure. The pump supplies water to a supply line that runs the perimeter of the building along the ceiling. Extremely large warehouses may require additional supply lines that run across the center of the building along the ceiling. Feeder lines run from the supply lines down to individual risers which control the water supply to individual sprinkler circuits arranged in zones that cover distinct areas.

In contrast to existing systems, the present invention is contained entirely within the structure for ease of maintenance, cost effectiveness, and reliability.

### DETAILED DESCRIPTION OF THE PREFERRED EMBODIMENT

For purposes of illustration, a preferred embodiment of the present invention is lustrated n FIG. 1 as a fire suppression system 10 incorporating a plurality of atomizing nozzles 11, for an enclosed area 22 of a building 20 or other similar structure (e.g. a large vessel, etc.). For purposes of orientation and reference, the building 20 includes a floor 24, a ceiling 26, and a plurality of walls 28 extending vertically between the floor and ceiling.

The system 10 generally includes a pipe network 30 of multiple interconnected pipes 35 for conveying a liquid tire suppressant toward the enclosed area 22. The pipe network 30 generally has an input end 32 for receiving a liquid tire suppressant and a plurality of outlet ports 34 for discharging clean agent into the enclosed area 22. In a typical systems, the pipe network 30 generally extends throughout the ceiling 26 and/or the walls 28 of the building 20. In either event, the outlet ports 34 are typically provided by vertically downward extending branch pipes 38.

At the input end 32 of the pipe network 30, the pipe network 30 is connected to a liquid fire suppressant 50 source such as a pump 40 that forces liquid fire suppressant 50 through a valve 42 two-way valve, or other suitable valve having open and closed states for selectively allowing or preventing flow. The valve 42 is actuated by a manual user control 43 or automatic control in response to a fire sensor, depending upon the system to allow the liquid fire suppressant 50 to flow through the pipe network 30. The liquid fire suppressant 50 utilized is preferably, but not necessarily, water.

At the output end 60 of the pipe network 30, the pipe network 30 is connected to a riser input port 61 by riser supply lines 62. The riser output port 65 is connected to sprinkler supply lines 70 by a sprinkler supply line main 72. The sprinkler supply lines 70 supply outlet ports 34 fitted with sprinkler heads 74. The sprinkler heads 74 are supplied via the sprinkler supply line 76 that extends from the sprinkler supply lines 70 and terminates at the outlet port 34 that is preferably fitted with a sprinkler head 74. In some instances and depending on the type of liquid fire suppressant used, an atomizer might be utilized instead of a sprinkler.

The riser 63 is a pump which serves to maintain adequate pressure in the sprinkler supply lines 70. The pressure in the pipe network drops with increased distance from the pump. The riser 63 attempts to compensate for the pressure drop by pumping an adequate supply of water into the sprinkler supply lines 70.

Upon the occurrence of a fire in the enclosed area 22, the liquid fire suppressant 50 is preferably delivered through heat sensitive sprinklers at a rate sufficient to extinguish the flames. Each protection zone is actuated as a whole when a fire is detected. Methods of detection include heat sensitive sprinklers, smoke detectors or other means known to those skilled in the art. The inclusion of individual riser pumps for each zone permits the independent protection zone actuation preferred in warehouse and hangars. Independent actuation is important so that the fire can be contained without damaging the goods stored in the zones unaffected by the fire. In some applications, surrounding protection zone sprinklers may be actuated to help contain the fire.

All of the references cited herein, including patents, patent applications, and publications, are hereby incorporated in their entireties by reference.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use, contemplated. All such modifications and variations are within the scope of the invention as determined by the appended claims when interpreted in accordance with the breadth to which they are fairly, legally, and equitably entitled.

What is claimed is:

1. A fire suppressant system comprising:
a. a pump capable of conveying a fire suppressant material, said pump housed within a structure to be protected;
b. a riser supply main capable of receiving said fire suppressant material conveyed from said pump and further conveying said fire suppressant material to a riser supply loop, said riser supply loop capable of conveying said fire suppressant material and further installed within and along the perimeter of said structure to be protected;
c. riser supply lines capable of receiving said fire suppressant material from said riser supply loop and conveying said fire suppressant material to a plurality of risers capable of conveying said fire suppressant material, each said riser only conveying said fire suppressant material to a single protection zone among a plurality of said protection zones within said structure; and
d. sprinkler supply lines within each said protection zone, said sprinkler supply lines capable of receiving said fire suppressant material from a single said riser and capable of conveying said fire suppressant material to a plurality of fire suppressant material delivery mechanisms.

2. The system of claim 1, wherein said riser supply main, riser supply loop, riser supply lines, and sprinkler supply lines are comprised of metal.

3. The system of claim 2, wherein said riser supply main, riser supply loop, riser supply lines, and sprinkler supply lines are comprised of cement lined steel pipes.

4. The system of claim 1, wherein said riser supply loop is installed above the floor of said structure to be protected.

5. The system of claim 1, wherein said delivery mechanisms are overhead, heat actuated sprinklers.

6. The system of claim 1, wherein said fire suppressant material is water.

7. The system of claim 1, wherein said fire suppressant material is a non-flammable foam.

8. The system of claim 1, wherein said pump, riser, riser supply main, riser supply loop, riser supply lines, and sprinkler supply lines are all housed with said structure to be protected.

9. A fire suppressant system comprising:
a. a pump capable of conveying water, said pump housed within a structure to be protected;
b. a riser supply main capable of receiving said water conveyed from said pump and further conveying said water to a riser supply loop, said riser supply loop capable of conveying said water and further installed within and along the perimeter of said structure to be protected;
c. riser supply lines capable of receiving water from said riser supply loop and conveying said water to a plurality of risers capable of conveying said water, each said riser only conveying said water to a single protection zone among a plurality of said protection zones within said structure;
d. sprinkler supply lines within each said protection zone, said sprinkler supply lines capable of receiving said comprised of cement lined steel pipes from a single said riser and capable of conveying said water to a plurality of overhead sprinklers; and
e. all piping being comprised of cement lined steel pipes.

10. The method of supplying a zoned warehouse sprinkler system using a pump housed within said warehouse and in which all pumps, risers, and pipes are installed within the structure of said warehouse so as to be readily accessible and visible, said water mains and supply lines being composed of cement coated pipe.
